(19) United States
(12) Patent Application Publication
(10) Pub. No.: US 2026/0079615 A1
(43) Pub. Date: Mar. 19, 2026

(54) EFFECT EDITING METHOD, ELECTRONIC DEVICE AND STORAGE MEDIUM

(71) Applicant: Beijing Zitiao Network Technology Co., Ltd., Beijing (CN)

(72) Inventors: Zhou YANG, Beijing (CN); Zhong CHAI, Beijing (CN); Zhe LI, Beijing (CN)

(21) Appl. No.: 19/317,811

(22) Filed: Sep. 3, 2025

(30) Foreign Application Priority Data
Sep. 14, 2024 (CN) 202411295819.5

(51) Int. Cl. G06F 3/04845; G06F 3/0486; G06T 11/60

(52) U.S. Cl. CPC G06F 3/04845; G06T 11/60; G06F 3/0486; G06T 2200/24

(57) ABSTRACT

Embodiments of the present disclosure provide an effect editing method, an electronic device and a storage medium. The method includes: displaying an effect editing interface; in which the effect editing interface includes a first effect image; the first effect image is an outcome image obtained by acting a plurality of effect objects to an image to be processed; each of the plurality of the effect objects includes at least one effect element; in response to a layer adjustment operation corresponding to the at least one effect element, updating an action outcome of the at least one effect element in the image to be processed based on an adjusted layer to obtain a second effect image, and displaying the second effect image.

### CROSS-REFERENCE TO RELATED APPLICATIONS

This application claims the priority to and benefits of the Chinese Patent Application, No. 202411295819.5, which was filed on Sep. 14, 2024. All the aforementioned patent applications are hereby incorporated by reference in their entireties.

### TECHNICAL FIELD

Embodiments of the present disclosure relate to an effect editing method, an electronic device and a storage medium.

### BACKGROUND

With the rapid development of digital image technology, people put forward higher requirements for visual outcome of an image. In order to increase the artistry and interest of the image, adding effects to the image has become an important technical means. Effects can bring richer visual outcome to the image, and make the image more attractive and ornamental.

However, although some software programs or applications on the market have provided the function of effect editing, effect editing operations supported by these software programs or applications are limited, which cannot meet the diverse needs of users.

### SUMMARY

The present disclosure provides an effect editing method, an apparatus, an electronic device, a storage medium and a program product, so as to realize more flexible and refined effect editing on an effect image, and make the effect editing more personalized and interesting.

In a first aspect, an embodiment of the present disclosure provides an effect editing method, the method including:
displaying an effect editing interface; in which the effect editing interface includes a first effect image; the first effect image is an outcome image obtained by acting a plurality of effect objects to an image to be processed; each of the plurality of the effect objects includes at least one effect element;
in response to a layer adjustment operation corresponding to the at least one effect element, updating an action outcome of the at least one effect element in the image to be processed based on an adjusted layer to obtain a second effect image, and displaying the second effect image.

In a second aspect, an embodiment of the present disclosure further provides an effect editing apparatus, the apparatus including:
an interface display module, configured to display an effect editing interface; in which the effect editing interface includes a first effect image; the first effect image is an outcome image obtained by applying a plurality of effect objects to an image to be processed; each of the plurality of the effects object includes at least one effect element;
a layer adjustment module, configured to, in response to a layer adjustment operation corresponding to the at least one effect element, update an action outcome of the at least one effect element in the image to be processed based on an adjusted layer to obtain a second effect image, and display the second effect image.

In a third aspect, an embodiment of the present disclosure further provides an electronic device, the electronic device including:
one or more processors;
a storage apparatus, configured to store one or more programs,
in which in response to the one or more programs are executed by the one or more processors, the one or more processors are caused to implement the effect editing method of any one of the embodiments of the present disclosure.

In a fourth aspect, an embodiment of the present disclosure further provides a storage medium containing a computer-executable instruction, the computer-executable instruction, when executed by a computer processor, causes the computer processor to execute the effect editing method of any one of the embodiments of the present disclosure.

In a fifth aspect, an embodiment of the present disclosure further provides a computer program product, the computer program product includes a computer program, that, when executed by a processor, causes the processor to implement the effect editing method of any one of embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a schematic flow diagram of an effect editing method provided by an embodiment of the present disclosure;

FIG. 2 is a schematic flow diagram of another effect editing method provided by an embodiment of the present disclosure;

FIG. 3 is a schematic flow diagram of another effect editing method provided by an embodiment of the present disclosure;

FIG. 4 is an effect editing architecture diagram suitable for an effect editing method provided by an embodiment of the present disclosure;

FIG. 5 is a schematic structural diagram of an effect editing apparatus provided by an embodiment of the present disclosure; and

FIG. 6 is a schematic structural diagram of an electronic device provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

Names of messages or information exchanged among multiple devices in the embodiment of the present disclosure are only used for illustrative purposes, and are not used to limit the scope of these messages or information.

It can be understood that before using the technical solutions disclosed in various embodiments of this disclosure, users should be informed of the types, scope of use, use scenarios, etc. of personal information involved in this disclosure in an appropriate way according to relevant laws and regulations and be authorized by users.

For example, in response to receiving the user's active request, prompt information is sent to the user to clearly remind the user that the operation requested by the user will require obtaining and using the user's personal information. Therefore, the user can independently choose whether to provide personal information to software or hardware such as electronic devices, applications, servers or storage media that perform the operation of the technical scheme of the present disclosure according to the prompt information.

As an optional but non-limiting implementation, in response to receiving the user's active request, the way to send the prompt information to the user can be, for example, a pop-up window, in which the prompt information can be presented in text. In addition, the pop-up window can also carry a selection control for the user to choose “agree” or “disagree” to provide personal information to the electronic device.

It can be understood that the above process of notifying and obtaining user authorization is only schematic, and does not limit the implementation of this disclosure. Other ways to meet relevant laws and regulations can also be applied to the implementation of this disclosure.

It can be understood that the data involved in this technical scheme (including but not limited to the data itself, data acquisition or use) should comply with the requirements of corresponding laws, regulations and relevant regulations.

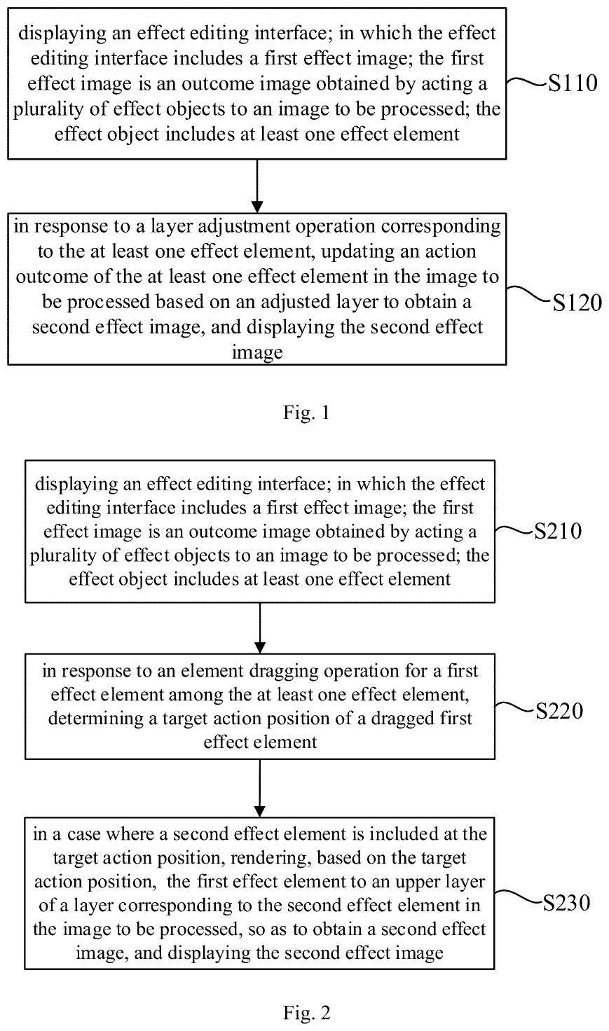

FIG. 1 is a schematic flow diagram of an effect editing method provided an embodiment of the present disclosure. The embodiment of the present disclosure is suitable for a situation where effects are edited, and the method may be executed by an effect editing apparatus, which may be implemented in a form of software and/or hardware, or optionally, by an electronic device, and the electronic device may be a mobile terminal, a PC, a server, or the like.

As shown in FIG. 1, the method of the present embodiment may specifically include:

S110: displaying an effect editing interface; in which the effect editing interface includes a first effect image; the first effect image is an outcome image obtained by acting a plurality of effect objects to an image to be processed; the effect object includes at least one effect element.

In an embodiment of the present disclosure, the effect editing interface may be understood as an interactive interface associated with an effect editing operation. Specifically, the effect editing interface may be configured to perform an effect editing on an outcome image of an image to be processed on which a plurality of effect objects act, that is, to perform an effect editing on a first effect image. In other words, the effect editing interface may be configured to perform a secondary effect editing on a plurality of effect objects applied in the image to be processed. In addition, the effect editing interface can also be configured for a first effect editing of the image to be processed. The image to be processed can be understood as an image that requires an effect processing. The image to be processed can be an image shot based on a shooting control, or an image uploaded by an uploading control. The image to be processed may be a single image, or an image obtained from an image sequence (e.g., a video) containing a plurality of graphics.

The first effect image can be understood as an outcome image obtained by applying a plurality of effect objects to the image to be processed. The effect object can be understood as an object edited in advance for performing an effect processing on the image to be processed to present an expected outcome of the effect. Specifically, the effect object may include an object that is edited according to at one or more effect element to present an expected outcome of the effect, an effect processing algorithm, and an effect file. For example, the effect object may be a target effect file published in an effect application scenario. The effect element may include, but is not limited to, at least one of elements such as a sticker element, a text element, a filter algorithm, and a transition algorithm. In an embodiment of the present disclosure, the effect object may include at least one effect element. The effect element may be understood as an atomic effect in an effect object, for example, the effect object is an effect file composed of a plurality of stickers, and the effect element included in the effect object may be a single sticker in the effect object.

It should be noted that, in the embodiment of the present disclosure, it is supported to add a plurality of effect objects to the image to be processed. As an optional implementation of the embodiment of the present disclosure, displaying the effect editing interface may include: obtaining an image to be processed in response to an effect trigger operation; in response to an effect adding operation for the image to be processed, adding the effect object to the image to be processed according to a default layer corresponding to the effect object to obtain a first effect image, and displaying the first effect image in the effect editing interface.

On this basis, as an optional implementation of the embodiment of the present disclosure, in response to the effect adding operation for the image to be processed, adding the effect object to the image to be processed according to the default layer corresponding to the effect object, may include: displaying a first effect identification corresponding to the effect object, in which the first effect identification may be configured to distinguish different effect objects; in response to a dragging operation for the first effect identification, acting the effect object corresponding to a dragged first effect identification on the image to be processed according to the default layer corresponding to the effect object. Therefore, an outcome image of an image to be processed on which a plurality of effect objects are acted can be obtained.

As another optional implementation of the embodiment of the present disclosure, in response to the effect adding operation for the image to be processed, adding the effect object to the image to be processed according to the default layer corresponding to the effect object, may include: displaying a second effect identification corresponding to the effect object, in which the second effect identification may be configured to distinguish different effect objects; in response to a selection trigger operation for the second effect identification, acting the effect object corresponding to a selected second effect identification on the image to be processed according to the default layer corresponding to the effect object.

In the embodiments of the present disclosure, the effect editing interface may include an effect shooting interface and/or an effect creation interface. The effect shooting interface can be configured at least to shoot the image to be processed and edit the effect object corresponding to the image to be processed. The effect creation interface may be configured to create an effect file based on an effect object. The image to be processed of the effect creation interface is generally a template image. The effect creation interface can also be configured to preview the outcome of the effect of the effect object based on the template image (the image to be processed).

As an optional implementation of the embodiment of the present disclosure, in a case where the effect editing interface includes an effect shooting interface, an image shooting may be performed through the effect shooting interface to obtain the image to be processed; in response to an effect adding operation input in the effect shooting interface, a plurality of effect objects are added in the image to be processed, and an outcome image, that is, the first effect image, obtained after acting the plurality of effect objects on the image to be processed is displayed.

As another optional implementation of the embodiment of the present disclosure, in a case where the effect editing interface includes the effect creation interface, the image to be processed of the effect creation interface may be a default template image or a template image selected from a target gallery based on a selection control. The effect creation interface can include an effect editing region and an effect preview region; a plurality of effect identifications are displayed in the effect editing region. Optionally, displaying the effect editing interface may include: in response to an identification trigger operation for the effect identification in the effect editing region of the effect creation interface, adding an effect object corresponding to a triggered effect identification to the template image to obtain the first effect image.

Further, in response to an effect generation trigger operation, generating a target effect file based on the effect object corresponding to the triggered effect identification. It can be understood that, one or more effect objects can be included in the target effect file.

S120: in response to a layer adjustment operation corresponding to the at least one effect element, updating an action outcome of one of the at least one effect element in the image to be processed based on an adjusted layer to obtain a second effect image, and displaying the second effect image.

The layer adjustment operation can be understood as an operation for adjusting the layer where the effect element is located. In other words, the layer adjustment operation may be configured to adjust the effect element from the first layer to the second layer. The second effect image can be obtained by updating the action outcome of the effect element in the image to be processed based on the adjusted layer. In other words, the second effect image may be an outcome image obtained by performing a layer adjustment to the effect element in the first effect image.

Specifically, after receiving the layer adjustment operation corresponding to at least one of effect element, the adjusted layer may be obtained. Furthermore, the action outcome of the effect element in the image to be processed can be updated based on the adjusted layer. Therefore, the outcome image after the effect adjustment for the image to be processed can be obtained, that is, the second effect image can be obtained. After obtaining the second effect image, the second effect image can be displayed.

Optionally, the effect editing interface includes a preset layer adjustment control and/or an object editing track, etc. In the embodiment of the present disclosure, the layer adjustment operation corresponding to at least one effect element, may include: an element selection operation for the at least one effect element and a control trigger operation for a layer adjustment control in case of the effect editing interface including the layer adjustment control.

The element selection operation can be understood as an operation configured to select the effect element (for example, click operation, etc.). The layer adjustment control can be configured to adjust the layer where the effect element in the effect object acting on the image to be processed is located.

Optionally, the layer adjustment control may include at least one control among a layer switching control, a layer deleting control, a layer adding control, a layer moving up control, a layer moving down control, and the like. The layer switching control is configured to switch the layer corresponding to the effect element according to a preset switching rule (for example, random switching, top-down, bottom-up, etc.).

In an embodiment of the present disclosure, in a case where the effect editing interface includes a preset layer adjustment control, an element selection operation for at least one effect element may be received first, and a selected effect element may be determined. Furthermore, the selected effect element can be bound with the layer adjustment control. Thereafter, the selected effect element may be adjusted after a control trigger operation acting on the layer adjustment control is received. Exemplarily, the layer adjustment control may include the layer deleting control. After the selected effect element is bound with the layer adjustment control, and the control trigger operation acting on the layer deleting control is received, the layer where the selected effect element is located can be deleted.

In an embodiment of the present disclosure, the layer adjustment operation corresponding to at least one effect element, may include: a track adjustment operation for one or more effect elements in object editing tracks corresponding to the plurality of effect objects in case of the effect editing interface including the object editing tracks.

The object editing track can be configured to edit effect on the effect object acting on the image to be processed. The object editing track can be configured to distinguish different effect objects and effective time corresponding to the effect object. In other words, the effective time and the acting image to be processed of the effect object are associated with the position of the effect object in the object editing track. Different object editing tracks may correspond to different types of effect objects. The object editing track may include at least one meta track. For example, the track adjustment operation may be an adjustment operation of the track position of the object editing track and/or an adjustment operation of the object editing track where the effect object is located, or the like.

As an optional implementation of the embodiment of the present disclosure, in a case where the effect editing interface includes an effect shooting interface, an image shooting may be performed through the effect shooting interface, so as to obtain the image to be processed; in response to the effect adding operation input in the effect shooting interface, a plurality of effect objects are added in the image to be processed, and an outcome image, that is, a first effect image, obtained after acting the plurality of effect objects to the effect image to be processed is displayed. Based on this, in a case where the outcome image of the image to be processed acted with a plurality of effect objects is displayed in the effect shooting interface, the effect object corresponding to the object to be processed can be edited based on the effect shooting interface, which realizes the integration of effect shooting and effect editing.

According to the technical solution of the embodiment of the present disclosure, by displaying the effect editing interface including the first effect image, the effect processing outcome of the image to be processed can be intuitively and timely observed in the effect editing interface, and because the first effect image is an outcome image obtained by acting a plurality of effect objects to the image to be processed, and the effect object includes at least one effect element, a superimposed application of the plurality of effect objects can be realized, so that the first effect image presents rich the outcome of the effect. Then, by responding to the layer adjustment operation corresponding to at least one effect element, updating the action outcome of the effect element in the image to be processed based on the adjusted layer to obtain a second effect image, and displaying the second effect image, the layer adjustment of the effect element in the effect object is supported in the interaction dimension, which realizes more finer-grained effect editing, even if the same effect object is added to the image to be processed, different outcome of the effect can also be displayed through the adjustment of the effect element, which enriches interactive mode and outcome of the effect of the effect editing, solves the technical problem of poor flexibility of effect editing in related technologies, realizes more flexible and refined effect editing of the effect image, increases interest of the effect editing, and improves effect editing experience.

FIG. 2 is a schematic flow diagram of another effect editing method provided by an embodiment of the present disclosure. On the basis of the above embodiments, the technical solution of the present embodiment further refines the layer adjustment operation corresponding to at least one effect element. Optionally, the layer adjustment operation corresponding to at least one effect element, includes: an element dragging operation of a first effect element among the at least one effect element to a position of a second effect element, in which the second effect element overlaps with at least a portion of a display region of the first effect element. On this basis, updating the action outcome of the at least one effect element in the image to be processed based on the adjusted layer to obtain the second effect image, includes: determining a target action position of the first effect element, and rendering, based on the target action position and the effect processing image, the first effect element to an upper layer of a layer corresponding to the second effect element, so as to obtain a second effect image. Detailed implementation can be found in the description of the present embodiment. Among them, the same or similar technical features as those in the previous embodiments will not be described herein.

As shown in FIG. 2, the method of the present embodiment may specifically include:

S210: displaying an effect editing interface; in which the effect editing interface includes a first effect image; the first effect image is an outcome image obtained by acting a plurality of effect objects to an image to be processed; the effect object includes at least one effect element.

S220: in response to an element dragging operation for a first effect element among the at least one effect element, determining a target action position of the first effect element.

The first effect element can be understood as a dragged effect element in the effect elements. The number of the first effect element may be one, two, or more. The element dragging operation can be configured to drag the effect element to change the position of effect element. The target action position may include the action position of the first effect element in the image to be processed at the end of the element dragging operation.

It can be understood that, in a case where the image to be processed includes a plurality of effect elements, the layer where the first effect element of the effect elements is located may be at the upper level of the layer where the second effect element of the effect elements is located, or may be at the lower level of the layer where the second effect element is located. It should be noted that the first effect element and the second effect element are relative to each other. For example, the effect element acted on the image to be processed can include a “Star” type sticker and a “Moon” type sticker. In a case where the “star” type sticker is dragged to the position of the “moon” type sticker, the “star” type sticker may be configured as the first effect element, and the “moon” type sticker may be configured as the second effect element. In a case where the “moon” type sticker is dragged to the position of the “star” type sticker, the “moon” type sticker may be configured as the first effect element, and the “star” type sticker may be configured as the second effect element.

In an embodiment of the present disclosure, the method of determining the first effect element may specifically be that, the selected effect element may be determined in response to a selection operation for the effect element. Here, the number of the selected effect element may be one, two, or more, which is not specifically limited here, and may be selected according to actual needs. After determining the selected effect element, the selected effect element can be taken as the first effect element. To visually display how to edit the effect element, after receiving the selection operation for the effect element, the selected effect element can be highlighted. For example, a preset identification (for example, a border corresponding to the size of the effect element) can be added to the selected effect element, the selected effect element can be enlarged to display, and the display color of the selected effect element can be adjusted.

Specifically, the first effect element may be dragged based on the element dragging operation, and the target action position of the first effect element in the image to be processed may be acquired at the end of the element dragging operation, or when the first effect element is released. More specifically, a dragging start position and a dragging end position may be determined according to the element dragging operation, and a dragging displacement and a dragging direction may be determined according to the dragging start position and the dragging end position. An initial action position of the first effect element can be acquired, and a target action position of the first effect element is determined according to the initial action position and the dragging displacement.

S230: in a case where a second effect element is included at the target action position, rendering, based on the target action position, the first effect element to an upper layer of a layer corresponding to the second effect element in the image to be processed, so as to obtain a second effect image, and displaying the second effect image.

In an embodiment of the present disclosure, the second effect element is an effect element other than the first effect element in the effect elements. The target action position includes a second effect element, which can be understood that, there is an effect element at the target action position that overlaps at least a portion of the action region of the dragged first effect element. In other words, the second effect element can be understood as, at the end of the element dragging operation of the first effect element, the effect element located at the position of the dragged first effect element. The number of the second effect elements may be one, two, or more.

Specifically, rendering, based on the target action position, the first effect element to an upper layer of a layer corresponding to the second effect element in the image to be processed, may include: determining the layer corresponding to the second effect element in the image to be processed, taking the previous layer located on the layer corresponding to the second effect element as the layer of the first effect element, and rendering the first effect element into the image to be processed based on the target action position and the layer of the first effect element, so that the display outcome of the first effect element is located on the upper layer of the second effect element. The rendered outcome image obtained after the rendering is completed is the second effect image. After obtaining the second effect image, the second effect image may be displayed. In the embodiment of the present disclosure, the action outcome of the first effect element and the second effect element on the image to be processed can be adjusted by the element dragging operation, and an outcome adjustment for the effect image can be realized simply, quickly and conveniently.

In short, in a case where the first effect element is dragged into the action region of the second effect element, the action outcome of the first effect element is displayed on the upper layer of the action outcome of the second effect element. In a case where the second effect element is dragged into the action region of the first effect element, the action outcome of the second effect element is displayed on the upper layer of the action outcome of the first effect element.

It can be understood that, in a case where a plurality of effect elements are included in the image to be processed, another effect element may be present at the target action position of the dragged first effect element, or there may be no other effect element. In a case where a second effect element is not included at the target action position, the first effect element is rendered into the image to be processed based on the target action position and an original layer of the first effect element, so as to obtain a second effect image, and the second effect image is displayed. In other words, in a case where a second effect element is not included at the target action position, the first effect element is rendered at the target action position in the image to be processed according to the original layer of the first effect element to obtain the second effect image, and the second effect image is displayed.

According to the technical solution of the embodiment of the present disclosure, by the element dragging operation of dragging the first effect element among the effect elements to a position of the second effect element, in which the second effect element overlaps with at least a portion of a display region of the first display region, and the action outcome of the effect element is updated in the image to be processed based on the adjusted layer, more convenient and flexible visual adjustment of the effect element are realized.

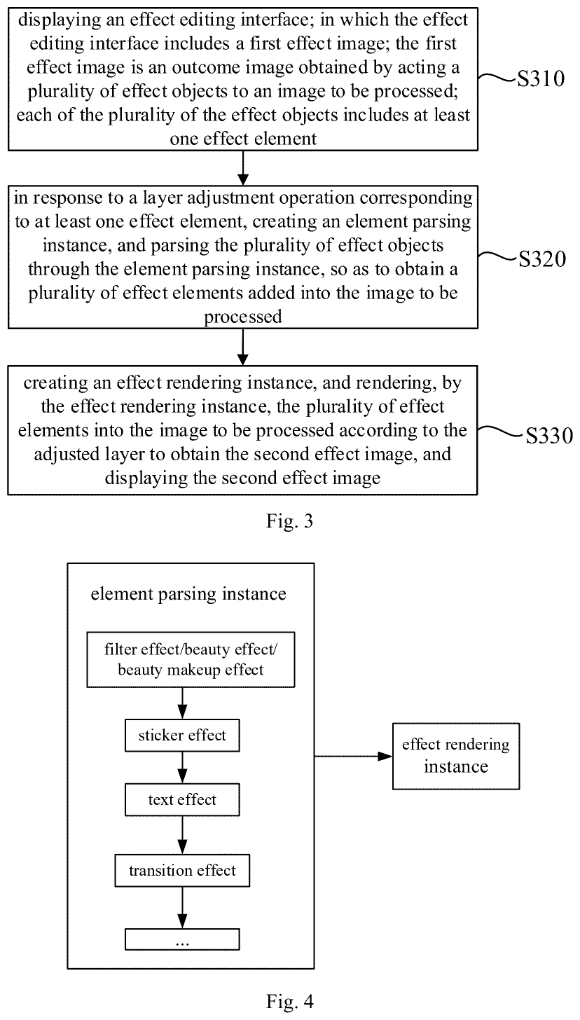

FIG. 3 is a schematic flow diagram of another effect editing method provided by an embodiment of the present disclosure. On the basis of the above embodiments, the technical solution of the present embodiment further refines updating the action outcome of the effect element in the image to be processed based on the adjusted layer. Optionally, the step of updating the action outcome of the effect element in the image to be processed based on the adjusted layer to obtain the second effect image, includes: creating an element parsing instance, and parsing the plurality of effect objects through the element parsing instance, so as to obtain a plurality of effect elements added in the image into be processed; creating an effect rendering instance, and rendering by the effect rendering instance, the plurality of effect elements into the image to be processed according to the adjusted layer to obtain the second effect image. Detailed implementation can be found in the description of the present embodiment. Among them, the same or similar technical features as those in the previous embodiments will not be described herein.

As shown in FIG. 3, the method of the present embodiment may specifically include:

S310: displaying an effect editing interface; in which the effect editing interface includes a first effect image; the first effect image is an outcome image obtained by acting a plurality of effect objects to an image to be processed; each of the plurality of the effect objects includes at least one effect element.

S320: in response to a layer adjustment operation corresponding to at least one effect element, creating an element parsing instance, and parsing the plurality of effect objects through the element parsing instance, so as to obtain a plurality of effect elements added into the image to be processed.

The element parsing instance can be understood as an instance configured to parsing the effect object into the effect element. In an embodiment of the present disclosure, the element parsing instance may include an instance of an element parsing class corresponding to a plurality of types of effect elements. An element parsing class can be understood as a class that performs an element parsing definition for different types of effect elements in advance, for example, an element parsing class of an effect element of a text type, an element parsing class of an effect element of a map type, an element parsing class of an effect element of a transition type, and the like. In an embodiment of the present disclosure, the element parsing class may inherit from an object parsing class. That is, the element parsing class can be a derived class of the object parsing class, and the object parsing class can be a base class of the element parsing class. In other words, an element parsing class may be a child class of the object parsing class, and the object parsing class may be a parent class of the element parsing class.

In an embodiment of the present disclosure, the object parsing class may include an element attribute field and an element parsing method corresponding to the effect element. That is, the object parsing class defines the element attribute field and the element parsing method corresponding to effect element. In an embodiment of the present disclosure, the element attribute field may include an field for storing element attribute information of the effect element; the element attribute information may include at least a layer where the effect element is located and a storage path; the element attribute information may further include action time and/or editable information of the effect element.

The layer where the effect element is located can be represented by a sorting of the layer where the effect element is located in all layers; alternatively, it may be represented by a layer adjacent to the layer where the effect element is located, the layer adjacent to the layer where the effect element is located can include a previous layer of the layer where the effect element is located and/or a next layer of the layer where the effect element is located. The storage path may indicate a storage location of the effect element. The storage path may be an absolute storage path, or a relative storage path. Optionally, the action time of the effect element may include action start time and action end time of effect element.

The editable information may include private information of the effect element, for example, a corresponding display region may be set for a sticker effect. It should be noted that whether or not the element attribute information stored by the element attribute field can be modified can be set by defining an access permission of the element attribute field. The access permission of the element attribute field may include a private type and a public type. It can be understood that, in a case where the access permission of the element attribute field is the private type, the element attribute information stored by the element attribute field cannot be modified; in a case where the access permission of the element attribute field is the public type, the element attribute information stored by the element attribute field can be modified. The element parsing method can be understood as a method defined in advance in the object parsing class and configured to parse the effect element.

In an embodiment of the present disclosure, the object parsing class may inherits from an object management class; the object management class may be configured to manage a life cycle corresponding to the effect object and a layer in which the effect object is located. The life cycle corresponding to the effect object may include a process from creation to destruction of the effect object. In the embodiment of the present disclosure, the object management class may be configured to manage the layer where the effect object is located in order to maintain the relationship between the effect object and the layer, so as to accurately determine the layer where the effect object is located and/or the effect object corresponding to the layer.

In an embodiment of the present disclosure, an object management class is defined in advance, an object parsing class inheriting the object management class is defined in advance, and at least one element parsing class inheriting the object parsing class is defined in advance, and different element parsing classes can be configured to parse different types of effect elements.

Based on this, after receiving the layer adjustment operation corresponding to at least one effect element, according to the inheritance relationship between classes, the parent class can be loaded first and then the child class can be loaded, that is, the object management class, the object parsing class, and the element parsing class can be loaded into the internal memory in turn. Furthermore, an instance of an element parsing class corresponding to a plurality of types of effect elements, that is, an element parsing instance, may be created. Furthermore, the plurality of effect objects can be parsed by the element parsing instance, so as to obtain the effect element included in each effect object, that is, the plurality of effect elements added in the image to be processed can be obtained.

Parsing the plurality of effect objects by the element parsing instance, specifically, for each effect object, a type of the effect element in the effect object may be determined. For each type of effect element in the effect object, the effect element in the effect object may be parsed by an instance of the element parsing class in the element parsing instance that matches the type of the effect element.

Existing effect object parsing often requires the use of different functional modules for effect parsing. Once there are many functional modules, the code has high coupling degree, low readability and poor maintainability, and is contrary to the development principle of high cohesion and low coupling. In response to parsing the effect element, corresponding functional module need to be loaded to the internal memory to create a plurality of instances, which has a technical problem of basic internal memory consumption. Compared with the existing effect object parsing, in the embodiment of the present disclosure, the plurality of effect objects are uniformly parsed by an element parsing instance, thereby realizing modularization of the effect object parsing function, reducing the code coupling degree, improving the code readability, improving the code maintainability, and conforming to the development principle. In the embodiment of the present disclosure, in response to parsing effect element, it is not necessary to create a plurality of instances to parse the effect object, and the basic internal memory consumption of the existing plurality of instances is reduced.

In addition, in the existing effect object parsing architecture, the sticker and the text often correspond to the same functional module. In response to inserting a target effect between the sticker effect and the text effect, then it is needed to create two effect instances of the sticker and the text, and insert an instance of the target effect between these two instances. Among them, the target effect is the effect that needs to be inserted. However, in the effect object parsing architecture of the embodiment of the present disclosure, as shown in FIG. 4, because the sticker effect and the text effect are managed by the same functional layer, that is, the sticker effect and the text effect are mutually independent effects.

Therefore, the target effect can be freely inserted between the sticker effect and the text effect. Moreover, in a case where the position of the text effect remains unchanged, the sticker effect can be located at the upper layer of the filtering effect, or at the lower layer of the filtering effect, so as to realize flexible editing of the sticker effect.

In order to improve the reuse flow of the code, in an embodiment of the present disclosure, the element parsing class may inherit from the object reuse class. The object reuse class can be understood as a predefined class for calling existing element parsing logic. The object reuse class may include a logic calling method, that is, the logic calling method is defined in the object reuse class. The logic calling method may be configured to call an existing element parsing logic. In the embodiment of the present disclosure, by inheriting the object reuse class by the element parsing class, the reuse of existing element parsing logic can be realized, and the compatibility of parsing the effect object can be improved. On this basis, in order to facilitate the management of the effect object, in the embodiment of the present disclosure, the object reuse class may inherit from the object management class to manage the existing effect object through the object management class.

S330: creating an effect rendering instance, and rendering, by the effect rendering instance, the plurality of effect elements into the image to be processed according to the adjusted layer to obtain the second effect image, and displaying the second effect image.

The effect rendering instance may be used to place a plurality of the effect element rendering in the image to be processed according to the adjusted figure tier. Effect rendering instances can be created by loading a predefined effect rendering class.

Specifically, an effect rendering class is defined in advance. In response to receiving a layer adjustment operation corresponding to at least one effect element, an adjusted layer can be obtained.

Then, the effect rendering instance can be created by loading the predefined effect rendering class into the internal memory. Furthermore, a plurality of effect elements can be rendered in the image to be processed according to the adjusted layer by the effect rendering instance. Therefore, the effect rendering result, that is, the second effect image, can be obtained. After obtaining the second effect image, the second effect image may be displayed.

According to the technical solution of the embodiment of the present disclosure, by creating an element parsing instance, and parsing the plurality of effect objects through the element parsing instance, so as to obtain a plurality of effect elements added into the image to be processed; and creating an effect rendering instance, and rendering, by the effect rendering instance, the plurality of effect elements into the image to be processed according to the adjusted layer to obtain the second effect image, unified parsing of the plurality of effect objects by the element parsing instance is realized, modularization of the effect object parsing function is realized, code coupling is realized, code readability is improved, and code maintainability is improved.

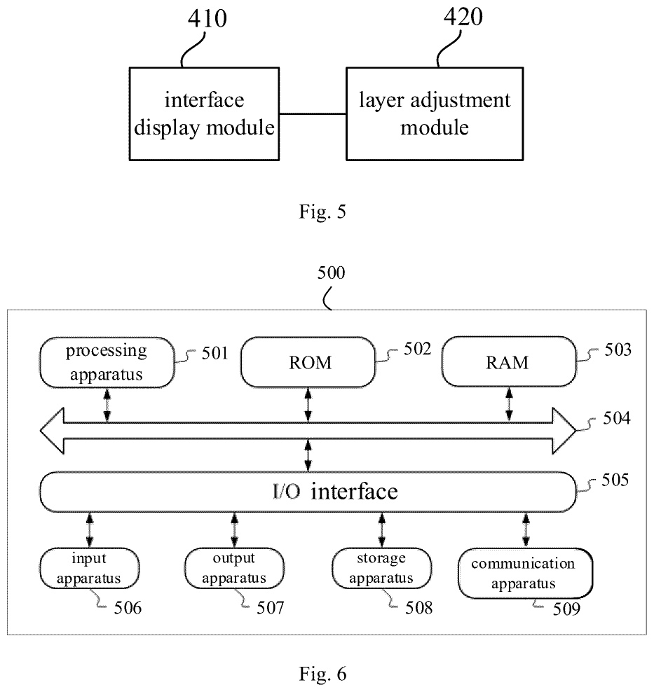

FIG. 5 is a schematic structural diagram of an effect editing apparatus provided by an embodiment of the present disclosure. As shown in FIG. 5, the apparatus includes an interface display module 410 and a layer adjustment module 420.

The interface display module 410 is configured to display an effect editing interface; the effect editing interface includes a first effect image; the first effect image is an outcome image obtained by acting a plurality of effect objects to an image to be processed; each of the plurality of the effects object includes at least one effect element; the layer adjustment module 420 is configured to, in response to a layer adjustment operation corresponding to the at least one effect element, update an action outcome of the at least one effect element in the image to be processed based on an adjusted layer to obtain a second effect image, and display the second effect image.

According to the technical solution of the embodiment of the present disclosure, by the interface display module, the effect editing interface is displayed; the effect editing interface includes a first effect image; and the first effect image is an outcome image obtained by acting a plurality of effect objects to an image to be processed. According to the technical solution, the effect image acted with a plurality of effect objects is intuitively displayed through the effect editing interface. The effect object includes at least one effect element. By the layer adjustment module, in response to a layer adjustment operation corresponding to the at least one effect element, an action outcome of the at least one effect element in the image to be processed is updated based on an adjusted layer to obtain a second effect image, and the second effect image is displayed, the finer-grained adjustment for effect element is realized, and the outcome of the effects is enriched. The technical solution of the embodiment of the present disclosure solves the technical problem of poor flexibility of effect editing in related technologies, realizes more flexible and refined effect editing of the effect image, so that the effect editing is more personalized and interesting.

On the basis of the above optional technical solutions, optionally, the layer adjustment module 420 includes a layer operation unit, the layer operation unit is configured to response to an element dragging operation of a first effect element among the at least one effect element to a position of a second effect element, in which the second effect element overlaps with at least a portion of a display region of the first effect element.

On the basis of the above optional technical solutions, optionally, the layer adjustment module 420 includes a layer adjustment unit, the layer adjustment unit is configured to determine a target action position of the first effect element, and render, based on the target action position, the first effect element to an upper layer of a layer corresponding to the second effect element in the image to be processed, so as to obtain the second effect image.

On the basis of the above optional technical solutions, optionally, the layer adjustment module 420 is specifically configured to create an element parsing instance, and parse the plurality of effect objects through the element parsing instance, so as to obtain a plurality of effect elements added into the image to be processed; and create an effect rendering instance, and render, by the effect rendering instance, the plurality of effect elements into the image to be processed according to the adjusted layer to obtain the second effect image.

On the basis of the above optional technical solutions, optionally, the element parsing instance includes an instance of an element parsing class corresponding to a plurality of types of effect elements; the element parsing class inherits from an object parsing class; the object parsing class includes an element attribute field and an element parsing method for a corresponding effect element; and the object parsing class inherits from an object management class; the object management class is configured to manage a life cycle for a corresponding effect object and a layer in which the effect object is located.

On the basis of the above optional technical solutions, optionally, the element attribute field includes a field for storing element attribute information of the effect element; the element attribute information includes at least a layer in which the effect element is located and a storage path for the effect element; and the element attribute information further includes action time and/or editable information of the effect element.

On the basis of the above optional technical solutions, optionally, the element parsing class further inherits from an object reuse class; the object reuse class includes a logic calling method, and the logic calling method is configured to call an existing element parsing logic.

On the basis of the above optional technical solutions, optionally, the layer adjustment module 420, is configured to response to at least one selected from a group of: an element selection operation for the at least one effect element and a control trigger operation for a layer adjustment control in case of the effect editing interface comprising the layer adjustment control; a track adjustment operation for one or more effect elements in object editing tracks corresponding to the plurality of effect objects in case of the effect editing interface comprising the object editing tracks, and combination thereof.

On the basis of the above optional technical solutions, optionally, the effect editing interface includes an effect shooting interface and/or an effect creation interface, and the effect shooting interface is configured at least to shoot the image to be processed and edit an effect object corresponding to the image to be processed.

The effect editing apparatus provided by the embodiment of the present disclosure can execute the effect editing method provided by any embodiment of the present disclosure, and has corresponding functional modules and beneficial outcome.

It is worth noting that each unit and module included in the above apparatus is only divided according to functional logic, but it is not limited to the above division, as long as the corresponding functions can be realized; in addition, the specific names of each functional unit are only for the convenience of distinguishing each other, and are not used to limit the protection scope of the embodiment of the present disclosure.

FIG. 6 is a schematic structural diagram of an electronic device provided by an embodiment of the present disclosure. Referring to FIG. 6 below, which shows a schematic structural diagram of an electronic device (such as the terminal device or server in FIG. 6) 500 suitable for implementing an embodiment of the present disclosure. A terminal device in the embodiment of the present disclosure may include but not limited to a mobile terminal such as a mobile phone, a notebook computer, a digital radio broadcasting receiver, a personal digital assistant (PDA), a portable android device (PAD), a portable multimedia player (PMP), a vehicle terminal (such as a vehicle navigation terminal), and a fixed terminal such as a digital television (TV) and a desktop computer. The electronic device shown in FIG. 6 is only an example and should not impose any limitations on the functions and usage scopes of the embodiments of the present disclosure.

As shown in FIG. 6, the electronic device 500 may include a processing apparatus (such as a central processing unit, a graphics processor, and the like) 501, which may execute various appropriate actions and processes according to a program stored in a read-only memory (ROM) 502 or a program loaded from a storage apparatus 508 to a random-access memory (RAM) 503. In the RAM 503, various programs and data required for operations of the electronic device 500 are further stored. The processing apparatus 501, the ROM 502, and the RAM 503 are connected to each other by a bus 504. An input/output (I/O) interface 505 is also connected to the bus 504.

Generally, the following apparatuses may be connected to the I/O interface 505: an input apparatus 506 such as a touch screen, a touch pad, a keyboard, a mouse, a camera, a microphone, an accelerometer, a gyroscope, etc.; an output apparatus 507 such as a liquid crystal display (LCD), a loudspeaker, a vibrator, etc.; a storage apparatus 508 such as a magnetic tape, and a hard disk, etc.; and a communication apparatus 509. The communication apparatus 509 may allow the electronic device 500 to perform wireless or wire communication with other devices to exchange data. Although FIG. 6 shows the electronic device 500 with various apparatuses, it should be understood that it is not required to implement or possess all the apparatuses shown. It may implement alternatively or possess the more or less apparatuses.

According to the embodiment of the present disclosure, the process described above with reference to the flowcharts may be achieved as a computer software program. For example, an embodiment of the present disclosure includes a computer program product, the computer program product includes a computer program loaded on a non-transitory computer-readable medium, and the computer program contains program codes for executing the method shown in the flowcharts. In such an embodiment, the computer program may be downloaded and installed from the network by the communication apparatus 509, or installed from the storage apparatus 508, or installed from ROM 502. When the computer program is executed by the processing apparatus 501, the above functions in the method in the embodiments of the present disclosure are executed.

The names of messages or information exchanged between a plurality of apparatus in the embodiment of the present disclosure are only used for illustrative purposes, and are not used to limit the scope of these messages or information.

The electronic device provided by the embodiment of the present disclosure belongs to the same inventive concept as the effect editing method provided by the above embodiment. For technical details not described in detail in the present embodiment, please refer to the above embodiment, and the present embodiment has the same beneficial outcome as the above embodiment.

An embodiment of the present disclosure provides a computer storage medium, on which a computer program is stored, which, when executed by a processor, realizes the effect editing method provided in the above embodiment.

It should be noted that the computer-readable medium mentioned above in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, device or device, or any combination thereof. More specific examples of the computer-readable storage medium may include, but not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that may be used by or in combination with an instruction execution system, device or device. In the present disclosure, the computer-readable signal medium may include a data signal propagated in a baseband or as a part of a carrier wave, in which computer-readable program codes are carried. This propagated data signal may take multiple forms, including but not limited to an electromagnetic signal, an optical signal or any suitable combination of the above. The computer-readable signal medium may also be any computer-readable medium other than the computer-readable storage medium, and may send, propagate or transmit a program used by or in combination with an instruction execution system, device or device. The program codes contained on the computer-readable medium may be transmitted by any suitable medium, including but not limited to: an electric wire, a fiber-optic cable, radio frequency (RF) and the like, or any suitable combination of the above.

In some implementation methods, a client and the server can communicate by using any currently known or future developed network protocol such as a hypertext transfer protocol (HTTP), and may communicate and interconnect with digital data in any form or medium (for example, a communication network). Examples of the communication network include a local area network (“LAN”), a wide area network (“WAN”), the Internet work (for example, the Internet) and an end-to-end network (for example, an ad hoc end-to-end network), as well as any currently known or to be researched and developed in the future.

The above computer-readable medium may be contained in the above electronic device; and it may also exist separately without being assembled into the server.

The above computer-readable medium carries one or more programs, and when the above one or more programs are executed by the electronic device, the electronic device: display an effect editing interface; in which the effect editing interface includes a first effect image; the first effect image is an outcome image obtained by acting a plurality of effect objects to an image to be processed; each of the plurality of the effect objects includes at least one effect element; and in response to a layer adjustment operation corresponding to the at least one effect element, update an action outcome of one of the at least one effect element in the image to be processed based on an adjusted layer to obtain a second effect image, and display the second effect image.

Computer program codes for performing the operations of the present disclosure may be written in one or more programming languages or a combination thereof, the programming languages include, but are not limited to, object-oriented programming languages such as Java, Smalltalk and C++, and further include conventional procedural programming languages such as “C” programming language or similar programming languages. The program codes may be entirely executed on a user's computer, partially executed on the user's computer, executed as an independent software package, partially executed on the user's computer and partially executed on a remote computer, or entirely executed on the remote computer or a server. In the case involving the remote computer, the remote computer may be connected to the user's computer through any type of network, including a local area network (LAN) or a wide area network (WAN), or may be connected to an external computer (for example, through the Internet using an Internet service provider).

The flowcharts and block diagrams in the accompanying drawings illustrate the architecture, function and operation of possible implementations of the systems, methods and the computer program product according to various embodiments of the present disclosure. In this regard, each block in the flowcharts or block diagrams may represent a module, a program segment, or a part of codes, which includes one or more executable instructions for implementing specified logical functions. It should also be noted that, in some alternative implementations, the functions noted in the blocks may occur out of the order noted in the accompanying drawings. For example, two blocks illustrated in succession may, in fact, be executed substantially in parallel, and may sometimes be executed in a reverse order, depending on the function involved. It should also be noted that, each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The involved modules described in the embodiments of the present disclosure may be implemented by a mode of software, or may be implemented by a mode of hardware. Herein, the name of the unit does not constitute a limitation on the unit itself in a certain situation. For example, the interface display module can also be described as “a module for displaying the effect editing interface”.

The functions described above in this article may be at least partially executed by one or more hardware logic components. For example, non-restrictive exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a tangible medium that may include or store a program used by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, device or device, or any suitable combination of the above. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, Example 1 provides an effect editing method, including: displaying an effect editing interface; in which the effect editing interface includes a first effect image; the first effect image is an outcome image obtained by acting a plurality of effect objects to an image to be processed; each of the plurality of the effect objects includes at least one effect element; and in response to a layer adjustment operation corresponding to the at least one effect element, updating an action outcome of the at least one effect element in the image to be processed based on an adjusted layer to obtain a second effect image, and displaying the second effect image.

According to one or more embodiments of the present disclosure, Example 2 provides the method of Example 1, further including, optionally, the layer adjustment operation corresponding to the at least one effect element includes: an element dragging operation of a first effect element among the at least one effect element to a position of a second effect element, in which the second effect element overlaps with at least a portion of a display region of the first effect element.

According to one or more embodiments of the present disclosure, Example 3 provides the method of Example 1, further including, optionally, updating the action outcome of the at least one effect element in the image to be processed based on the adjusted layer to obtain the second effect image, includes: determining a target action position of the first effect element, and rendering, based on the target action position, the first effect element to an upper layer of a layer corresponding to the second effect element in the image to be processed, so as to obtain the second effect image.

According to one or more embodiments of the present disclosure, Example 4 provides the method of Example 1, further including, optionally, updating the action outcome of the at least one effect element in the image to be processed based on the adjusted layer to obtain the second effect image, includes: creating an element parsing instance, and parsing the plurality of effect objects through the element parsing instance, so as to obtain a plurality of effect elements added into the image to be processed; and, creating an effect rendering instance, and rendering, by the effect rendering instance, the plurality of effect elements into the image to be processed according to the adjusted layer to obtain the second effect image.

According to one or more embodiments of the present disclosure, Example 5 provides the method of Example 1, further including, optionally, the element parsing instance includes an instance of an element parsing class corresponding to a plurality of types of effect elements; the element parsing class inherits from an object parsing class; the object parsing class includes an element attribute field and an element parsing method for a corresponding effect element; the object parsing class inherits from an object management class; the object management class is configured to manage a life cycle for a corresponding effect object and a layer in which the effect object is located.

According to one or more embodiments of the present disclosure, Example 6 provides the method of Example 1, further including, optionally, the element attribute field includes a field for storing element attribute information of the effect element; the element attribute information includes at least a layer where the effect element is located and a storage path for the effect element; the element attribute information further includes action time and/or editable information of the effect element.

According to one or more embodiments of the present disclosure, Example 7 provides the method of Example 1, further including, optionally, the element parsing class further inherits from an object reuse class; the object reuse class includes a logic calling method, and the logic calling method is configured to call an existing element parsing logic.

According to one or more embodiments of the present disclosure, Example 8 provides the method of Example 1, further including, optionally, the layer adjustment operation corresponding to the at least one effect element, includes at least one selected from a group of: an element selection operation for the at least one effect element and a control trigger operation for a layer adjustment control in case of the effect editing interface comprising the layer adjustment control, a track adjustment operation for one or more effect elements in object editing tracks corresponding to the plurality of effect objects in case of the effect editing interface comprising the object editing tracks; and combination thereof.

According to one or more embodiments of the present disclosure, Example 9 provides the method of Example 1, further including, optionally, the effect editing interface includes an effect shooting interface and/or an effect creation interface, and the effect shooting interface is configured at least to shoot the image to be processed and edit an effect object corresponding to the image to be processed.

According to one or more embodiments of the present disclosure, Example 10 provides an effect editing apparatus, including: an interface display module, configured to display an effect editing interface; in which the effect editing interface includes a first effect image; the first effect image is an outcome image obtained by acting a plurality of effect objects to an image to be processed; each of the plurality of the effects object includes at least one effect element; and a layer adjustment module, configured to, in response to a layer adjustment operation corresponding to the at least one effect element, update an action outcome of the at least one effect element in the image to be processed based on an adjusted layer to obtain a second effect image, and display the second effect image.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

Furthermore, although various operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An effect editing method, comprising:
displaying an effect editing interface, wherein the effect editing interface comprises a first effect image, the first effect image is an outcome image obtained by acting a plurality of effect objects to an image to be processed, and each of the plurality of the effect objects comprises at least one effect element; and
in response to a layer adjustment operation corresponding to the at least one effect element, updating an action outcome of the at least one effect element in the image to be processed based on an adjusted layer to obtain a second effect image, and displaying the second effect image.

2. The effect editing method according to claim 1, wherein the layer adjustment operation corresponding to the at least one effect element comprises:
an element dragging operation of dragging a first effect element among the at least one effect element to a position of a second effect element, wherein the second effect element overlaps with at least a portion of a display region of the first effect element.

3. The effect editing method according to claim 2, wherein updating the action outcome of the at least one effect element in the image to be processed based on the adjusted layer to obtain the second effect image, comprises:
determining a target action position of the first effect element, and rendering, based on the target action position, the first effect element to an upper layer of a layer corresponding to the second effect element in the image to be processed, so as to obtain the second effect image.

4. The effect editing method according to claim 1, wherein updating the action outcome of the at least one effect element in the image to be processed based on the adjusted layer to obtain the second effect image, comprises:
creating an element parsing instance, and parsing the plurality of effect objects through the element parsing instance, so as to obtain a plurality of effect elements added into the image to be processed; and
creating an effect rendering instance, and rendering, by the effect rendering instance, the plurality of effect elements into the image to be processed according to the adjusted layer, so as to obtain the second effect image.

5. The effect editing method according to claim 4, wherein the element parsing instance comprises an instance of an element parsing class corresponding to a plurality of types of effect elements; the element parsing class inherits from an object parsing class; the object parsing class comprises an element attribute field and an element parsing method for a corresponding effect element; the object parsing class inherits from an object management class; and the object management class is configured to manage a life cycle for a corresponding effect object and a layer in which the effect object is located.

6. The effect editing method according to claim 5, wherein the element attribute field comprises a field for storing element attribute information of the effect element; the element attribute information comprises at least a layer in which the effect element is located and a storage path for the effect element; and the element attribute information further comprises action time and/or editable information of the effect element.

7. The effect editing method according to claim 5, wherein the element parsing class further inherits from an object reuse class, the object reuse class comprises a logic calling method, and the logic calling method is configured to call an existing element parsing logic.

8. The effect editing method according to claim 1, wherein the layer adjustment operation corresponding to the at least one effect element comprises at least one selected from a group of:
an element selection operation for the at least one effect element and a control trigger operation for a layer adjustment control in case of the effect editing interface comprising the layer adjustment control;
a track adjustment operation for one or more effect elements in object editing tracks corresponding to the plurality of effect objects in case of the effect editing interface comprising the object editing tracks; and combination thereof.

9. The effect editing method according to claim 1, wherein the effect editing interface comprises an effect shooting interface and/or an effect creation interface, and the effect shooting interface is configured at least to shoot the image to be processed and edit an effect object corresponding to the image to be processed.

10. An electronic device, comprising:
one or more processors; and
a storage apparatus, configured to store one or more programs,
wherein the one or more programs, when executed by the one or more processors, cause the one or more processors to:
display an effect editing interface; wherein the effect editing interface comprises a first effect image; the first effect image is an outcome image obtained by acting a plurality of effect objects to an image to be processed; each of the plurality of the effect objects comprises at least one effect element;
in response to a layer adjustment operation corresponding to the at least one effect element, update an action outcome of the at least one effect element in the image to be processed based on an adjusted layer to obtain a second effect image, and display the second effect image.

11. The electronic device according to claim 10, wherein the layer adjustment operation corresponding to the at least one effect element comprises:
an element dragging operation of dragging a first effect element among the at least one effect element to a position of a second effect element, wherein the second effect element overlaps with at least a portion of a display region of the first effect element.

12. The electronic device according to claim 11, wherein updating the action outcome of the at least one effect element in the image to be processed based on the adjusted layer to obtain the second effect image, comprises:
determining a target action position of the first effect element, and rendering, based on the target action position, the first effect element to an upper layer of a layer corresponding to the second effect element in the image to be processed, so as to obtain the second effect image.

13. The electronic device according to claim 10, wherein updating the action outcome of the at least one effect element in the image to be processed based on the adjusted layer to obtain the second effect image, comprises:
creating an element parsing instance, and parsing the plurality of effect objects through the element parsing instance, so as to obtain a plurality of effect elements added into the image to be processed; and
creating an effect rendering instance, and rendering, by the effect rendering instance, the plurality of effect elements into the image to be processed according to the adjusted layer, so as to obtain the second effect image.

14. The electronic device according to claim 13, wherein the element parsing instance comprises an instance of an element parsing class corresponding to a plurality of types of effect elements; the element parsing class inherits from an object parsing class; the object parsing class comprises an element attribute field and an element parsing method for a corresponding effect element; the object parsing class inherits from an object management class; and the object management class is configured to manage a life cycle for a corresponding effect object and a layer in which the effect object is located.

15. The electronic device according to claim 14, wherein the element attribute field comprises a field for storing element attribute information of the effect element; the element attribute information comprises at least a layer in which the effect element is located and a storage path for the effect element; and the element attribute information further comprises action time and/or editable information of the effect element.

16. The electronic device according to claim 14, wherein the element parsing class further inherits from an object reuse class; the object reuse class comprises a logic calling method, and the logic calling method is configured to call an existing element parsing logic.

17. The electronic device according to claim 10, wherein the layer adjustment operation corresponding to the at least one effect element comprises at least one selected from a group of:
an element selection operation for the at least one effect element and a control trigger operation for a layer adjustment control in case of the effect editing interface comprising the layer adjustment control;
a track adjustment operation for one or more effect elements in object editing tracks corresponding to the plurality of effect objects in case of the effect editing interface comprising the object editing tracks; and
combination thereof.

18. The electronic device according to claim 10, wherein the effect editing interface comprises an effect shooting interface and/or an effect creation interface, and the effect shooting interface is configured at least to shoot the image to be processed and edit an effect object corresponding to the image to be processed.

19. A storage medium, comprising a computer-executable instruction, wherein the computer-executable instruction, when executed by a computer processor, causes the computer processor to:
display an effect editing interface; wherein the effect editing interface comprises a first effect image; the first effect image is an outcome image obtained by acting a plurality of effect objects to an image to be processed; each of the plurality of the effect objects comprises at least one effect element;
in response to a layer adjustment operation corresponding to the at least one effect element, update an action outcome of the at least one effect element in the image to be processed based on an adjusted layer to obtain a second effect image, and display the second effect image.

20. A computer program product, comprising a computer program, wherein the computer program, when executed by a processor, causes the processor to implement the effect editing method of claim 1.
